(19) United States
(12) Patent Application Publication
(10) Pub. No.: US 2017/0197602 A1
(43) Pub. Date: Jul. 13, 2017

(54) AUTONOMOUS APPLICATION OF ELECTROMECHANICAL BRAKE BOOSTER IN AN ELECTRIC VEHICLE

(71) Applicants: James R. Hollowell, Brownstown, MI (US); Jason Trombley, Metamora, MI (US); Zachary Rogalski, Rochester Hills, MI (US); Miles A. Christmas, Commerce, MI (US); Matthew Karkkainen, Royal Oak, MI (US)

(72) Inventors: James R. Hollowell, Brownstown, MI (US); Jason Trombley, Metamora, MI (US); Zachary Rogalski, Rochester Hills, MI (US); Miles A. Christmas, Commerce, MI (US); Matthew Karkkainen, Royal Oak, MI (US)

(21) Appl. No.: 14/993,161

(22) Filed: Jan. 12, 2016

(51) Int. Cl. B60T 13/74

(52) U.S. Cl. CPC B60T 13/741; B60T 2201/06

(57) ABSTRACT

A method of autonomously applying an electromechanical brake booster in an electric vehicle having the electromechanical brake booster includes determining with an electronic brake control unit whether the vehicle is at a standstill in forward or reverse. It includes then sending a message from the electronic brake control unit to an electronic powertrain control unit of the vehicle that the vehicle is at standstill. It includes then responding with the electronic brake control unit to a message from the electronic powertrain controller that a hold is to be applied by having the electronic powertrain controller apply the autonomous hold by applying electromechanical brake booster.

### FIELD

The present invention relates to a method of autonomously applying an electromechanical brake booster in an all-electric or hybrid electric vehicle.

### BACKGROUND

An electromechanical brake booster is a brake booster that boosts hydraulic pressure in a brake system without the use of vacuum. It should be understood that electromechanical brake boosters are also known as vacuumless brake boosters and electronically controlled brake boost modules. An electromechanical brake booster typically has an electric motor that is actuated to boost the hydraulic pressure. Such electromechanical brake boosters are being used in automotive vehicles particularly those where it is desirable that vacuum not be continuously generated, either by the use of a vacuum pump or by the internal combustion engine itself. All-electric vehicles and hybrid electric vehicles are such vehicles. One such electromechanical brake booster is the electromechanical brake booster known as the iBooster available from Robert Bosch GmbH.

FIG. 1 is a simplified diagram showing an electric vehicle 100 having an electromechanical brake booster 102. Electric vehicle 100 illustratively has an electric powertrain 101 and includes an electronic powertrain control unit 104 coupled to an electronic brake control unit 106. Electronic brake control unit 106 includes an electric parking brake control 108 coupled to an electric brake actuator 110 of left rear wheel 112 of electric vehicle 100 and to an electric brake actuator 114 of right rear wheel 116 of electric vehicle 100. Electromechanical brake booster 102 is coupled to a hydraulic circuit 118, representatively shown by hydraulic brake lines 120, of brake system 122 of electric vehicle 100. Hydraulic brake lines 120 are coupled to service brakes 124 of brake system 122 at each of the front and rear wheels. Service brakes 124 are for example disk brakes, drum brakes, or a combination of both.

Electronic brake control unit 106 is responsive to a driver of electric vehicle 100 pressing a brake pedal (not shown) of electric vehicle 100 to apply the service brakes 124 of electric vehicle 100 which includes applying electromechanical brake booster 102. As used herein, applying the electromechanical brake booster means that it is actuated to boost hydraulic pressure in hydraulic circuit 118 of brake system 122 and deapplying electromechanical brake booster 102 means that it is actuated to release the boost of hydraulic pressure. In this regard, electromechanical brake booster 102 is typically controlled by electronic brake control unit 106 which actuates it as appropriate.

There are driving situations where a vehicle is at a stop and the driver of the vehicle will hold the vehicle in position by maintaining power with the powertrain rather than using the service brakes. That is, the driver maintains the accelerator pedal depressed slightly so that the powertrain applies motive force to the wheels of the vehicle sufficient to keep the vehicle at a stop. One such driving condition is when the vehicle is stopped on a hill.

In electric vehicles, particularly those that have an electric powertrain, it is desirable that when the vehicle is at a stop, the electric powertrain does not remain energized for too long of a period. If the electric powertrain remains energized for too long of period when the vehicle is at a stop, it can experience distress conditions, such as high temperatures.

### SUMMARY

In accordance with an aspect of the present disclosure, a method of autonomously applying an electromechanical brake booster in an electric vehicle having the electromechanical brake booster includes determining with an electronic brake control unit whether the vehicle is at a standstill in forward or reverse, sending a message from the electronic brake control unit to an electronic powertrain control unit of the vehicle that the vehicle is at standstill, and responding with the electronic brake control unit to a message from the electronic powertrain controller that a hold is to be applied by having the electronic powertrain controller apply the autonomous hold by applying electromechanical brake booster. The autonomous hold is applied without a driver of the electric vehicle having applied service brakes of the vehicle by having pressed a brake pedal of the electric vehicle.

In an aspect, the method further includes having the electronic powertrain control unit turn motive power off to an electric powertrain of the electric vehicle upon the electromechanical brake booster having been applied in response.

In an aspect, the method further includes having the electronic brake control unit deapply the electromechanical brake booster in response to a message from the electronic powertrain control unit that the hold is to be released.

### BRIEF DESCRIPTION OF THE DRAWINGS

The present invention will become more fully understood from the detailed description and the accompanying drawings, wherein:

FIG. 1 is a simple diagrammatic view of a prior art electric vehicle; and

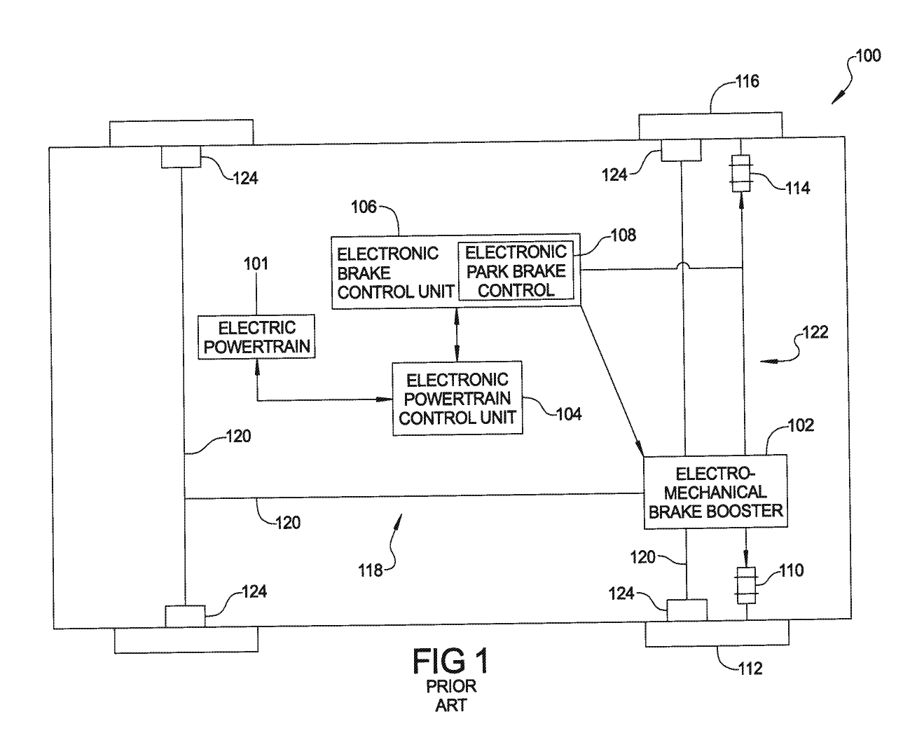

FIG. 2 is a flow chart illustrating a control routine for a method of autonomously applying an electromechanical brake booster of the electric vehicle of FIG. 1 in accordance with an aspect of the present disclosure.

### DETAILED DESCRIPTION

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

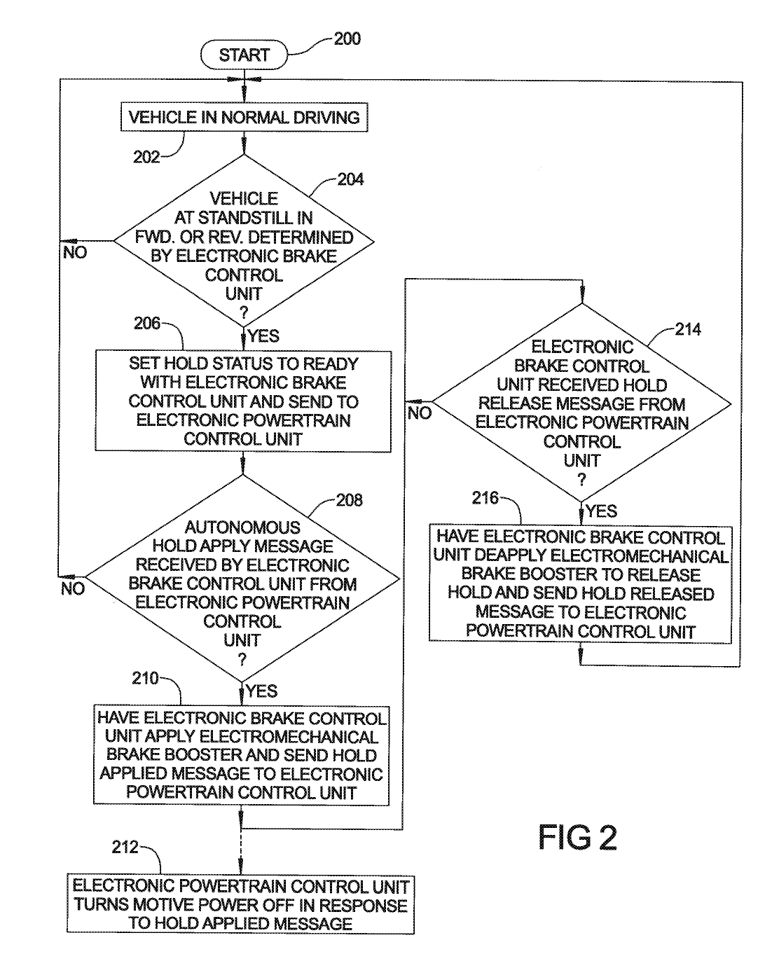

FIG. 2 is a flow chart illustrating a control routine for a method of autonomously applying electromechanical brake booster 102 of electric vehicle 100 in accordance with an aspect of the present disclosure. In an aspect, electric vehicle 100 is an all-electric vehicle and in another aspect, electric vehicle 100 is a hybrid electric vehicle. The control routine starts at 200. At 202, the electric vehicle 100 is in a normal driving condition. At 204, electronic brake control unit 106 checks whether electric vehicle 100 is at a standstill in either forward or reverse. As used herein, “standstill” means that the electric vehicle 100 is travelling at a speed of 2 kilometers per hour or less which includes zero kilometers per hour. Illustratively, electric vehicle 100 is in forward when its shifter (not shown) is in a D position and electric vehicle 100 is thus in or considered in a forward gear and is in reverse when its shifter is in an R position and electric vehicle 100 is thus in or considered in a reverse gear. If not, the control routine branches back to 204. If the electric vehicle is at standstill in either forward or reverse, the control routine proceeds to 208 where it sets hold status to ready and sends a message that hold status is ready to the electronic powertrain control unit 104. Hold status ready means that the electric vehicle 100 is in a state where an autonomous hold can be applied. Hold as used herein means the application of electromechanical brake booster 102 that in turns applies service brakes 124 of electric vehicle 100. Autonomous hold as used herein means a hold that is applied in response to electronic powertrain control unit determining that a hold should be applied when electric vehicle 100 is at standstill in forward or reverse. In this regard, the autonomous hold is applied by the application of the electromechanical brake booster to apply the service brakes of the vehicle without the driver of the electric vehicle having actuated the service brakes of the vehicle by pressing the brake pedal.

The control routine then proceeds to 208 where it has electronic brake control unit 106 determine if it has received an autonomous hold apply message from electronic powertrain control unit 104. If not, the control routine returns to 204. If at 208 electronic brake control unit 106 has received the autonomous hold apply message, the control routine proceeds to 210 where it has electronic brake control unit apply electromechanical brake booster 102 that in turns applies service brakes 124 of electric vehicle 100. The control routine also has electronic brake control unit 106 send a message to electronic powertrain control unit 104 that the electromechanical brake booster 102 has been applied and at 212 electronic powertrain control unit 104 turns motive power off to the electric powertrain 101 of electric vehicle 100.

In an aspect, electronic brake control unit 106 and electronic powertrain control unit 104 cooperate to blend the application of the electromechanical brake booster with reduction of motive power in the electric powertrain 101.

The control routine then proceeds to 214 where it has electronic brake control unit 106 determine whether it has received a hold release message from electronic powertrain control unit 104. If not, the control routine branches back to 214. If so, the control routine proceeds to 216 where it has electronic brake control unit 106 deapply the electromechanical brake booster 102 which in turn releases service brakes 124 of electric vehicle 100. The control routine then branches back to 204. In an aspect, electronic brake control unit 106 and electronic powertrain control unit 104 cooperate to blend the release of the autonomous hold with the application of motive power by the electric powertrain 101.

The application of electromechanical brake booster 102 in accordance with the foregoing control routine is autonomous in that the determination whether to apply a hold resulting in the electromechanical brake booster 102 is based on the state of electric vehicle 100 and does not require a driver to take an action, such as pressing a brake pedal, to cause the application of the electromechanical brake booster 102. Further, electronic brake control unit 106 is subservient to electronic powertrain control unit 104 in the ultimate determination of whether the autonomous hold should be applied. That is, electronic brake control unit 106 determines whether electric vehicle 100 is in a state where the autonomous hold can be applied but then defers to electronic powertrain control unit 104 for the final determination of whether the autonomous hold is to be applied.

In an aspect, the foregoing autonomous hold control routine is used as an autonomous hill hold control routine. That is, when electric vehicle 100 is at standstill on a hill and the driver is holding electric vehicle 100 in place on the hill by keeping the electric powertrain 101 powered by keeping an accelerator pedal (not shown) of electric vehicle 100 depressed sufficiently, the control routine will autonomously transition to applying the electromechanical brake booster to hold electric vehicle 100 in place and depower the electric powertrain 101 when the conditions for applying the autonomous hold discussed above are satisfied.

Electronic brake control unit 106 in which the above described control routine is implemented is or includes any of a digital processor (DSP), microprocessor, microcontroller, or other programmable device which are programmed with software implementing the above described methods. It should be understood that alternatively it is or includes other logic devices, such as a Field Programmable Gate Array (FPGA), a complex programmable logic device (CPLD), or application specific integrated circuit (ASIC). When it is stated that electronic brake control unit 106 performs a function or is configured to perform a function, it should be understood that electronic brake control unit 106 is configured to do so with appropriate logic (such as in software, logic devices, or a combination thereof). The foregoing is also applicable to electronic powertrain control unit 104.

The description of the invention is merely exemplary in nature and, thus, variations that do not depart from the gist of the invention are intended to be within the scope of the invention. Such variations are not to be regarded as a departure from the spirit and scope of the invention.

1. A method of autonomously applying an electromechanical brake booster in an electric vehicle having the electromechanical brake booster in which application of the electromechanical brake booster boosts hydraulic pressure in a hydraulic circuit of a braking system of a vehicle to apply the service brakes of the vehicle wherein an electronic brake control unit of the electric vehicle is responsive to a brake pedal of the vehicle being pressed to apply the electromechanical brake booster to apply the services brakes of the vehicle, the method comprising:
determining with the electronic brake control unit of the electric vehicle whether the electric vehicle is at a standstill in forward or reverse;
upon determining that the electric vehicle is at standstill in forward or reverse, sending with the electronic brake control unit a message to an electronic powertrain control unit of the electric vehicle that the electric vehicle is at standstill;
when the brake pedal of the vehicle is not being pressed having the electronic powertrain control unit determine whether to send an autonomous hold message to the electronic brake control and having the electronic powertrain control unit send the autonomous hold message to the electronic brake control when the electronic powertrain control unit determines that the autonomous hold message is to be sent to the electronic brake control unit; and
upon receiving with the electronic brake control unit a message from the electronic powertrain control unit that that an autonomous hold is to be applied, having the electronic brake control unit apply the autonomous hold by applying the electromechanical brake booster that applies the services brakes of the vehicle.

2. The method of claim 1 including having the electronic powertrain control unit turn motive power off to an electric powertrain of the electric vehicle upon the electromechanical brake booster having been applied.

3. The method of claim 1 including having the electronic brake control unit deapply the electromechanical brake booster to release the autonomous hold in response to a message from the electronic powertrain control unit that the autonomous hold is to be released.

4. (canceled)
